(19) United States
(12) Patent Application Publication
(10) Pub. No.: US 2016/0049148 A1
(43) Pub. Date: Feb. 18, 2016

(54) SMART INPUTTING DEVICE, SETTING METHOD AND CONTROLLING METHOD THEREOF

(71) Applicant: ALi Corporation, Hsinchu City (TW)

(72) Inventor: Xiao Wang, Guangdong (CN)

(73) Assignee: ALi Corporation, Hsinchu City (TW)

(21) Appl. No.: 14/550,309

(22) Filed: Nov. 21, 2014

(30) Foreign Application Priority Data
Aug. 12, 2014 (CN) 201410394671.0

(51) Int. Cl. G10L 15/22; G06F 3/16

(52) U.S. Cl. CPC G10L 15/22; G06F 3/167; G10L 2015/223

(57) ABSTRACT

A smart inputting device, a setting method and a controlling method thereof are provided. The smart inputting device includes a voice receiving unit and a plurality of buttons. The setting method of the smart inputting device includes following step. a voice command from a user is received by the voice receiving unit. A pressing signal generated from the buttons is sensed. A mapping data between the voice command and the pressing signal is recorded.

This application claims the benefit of People's Republic of China application Serial No. 201410394671.0, filed Aug. 12, 2014, the subject matter of which is incorporated herein by reference.

### BACKGROUND OF THE INVENTION

1. Field of the Invention

The invention relates in general to a smart inputting device, a setting method and a controlling method thereof, and more particularly to a voice controlling smart inputting device, a setting method and a controlling method thereof.

2. Description of the Related Art

Along with the advance in technology, various electronic devices are provided one after another. Besides, many electronic devices are further equipped with various inputting devices such as remote controller or keyboard. The user can input a predetermined inputting signal or controlling signal by pressing the button of an inputting device.

As the functions of electronic devices are getting more and more powerful, buttons of the inputting device are also getting more and more complicated and become unfriendly to the user. Thus, an inputting device using voice control is provided. For example, the user can input a shutdown controlling signal by saying “shutdown.”

The inputting device using voice control must firstly recognize and convert user voice into text, and subsequently calls a controlling signal corresponding to the text. In general, voice recognition is subjected to the restrictions in languages and pronunciation, and it is difficult to accurately recognize user voice and convert it into text. Thus, how to increase the accuracy in voice recognition for the inputting device using voice control has become a prominent task for the industries.

### SUMMARY OF THE INVENTION

The invention is directed to a smart inputting device, a setting method and a controlling method thereof. A mapping data between each user's voice commands and pressing signals is created. The recognition of voice is not restricted by user's languages and pronunciation, and the accuracy of the smart inputting device using voice control can be increased.

According to one embodiment of the present invention, a setting method of a smart inputting device is provided. The smart inputting device includes a voice receiving unit and a plurality of buttons. The setting method of a smart inputting device includes following step. A voice command from a user is received by the voice receiving unit. A pressing signal generated from the buttons is sensed. A mapping data between the voice command and the pressing signal is recorded.

According to another embodiment of the present invention, a controlling method of a smart inputting device is provided. The smart inputting device includes a voice receiving unit and a plurality of buttons. The controlling method of the smart inputting device includes following step. If the voice receiving unit receives a voice command from a user, a pressing signal generated from the buttons corresponding to the voice command is obtained according to a mapping data. An inputting signal is transmitting according to the pressing signal.

According to another embodiment of the invention, a smart inputting device is provided. The smart inputting device includes a plurality of buttons, a voice receiving unit, a database, a processing unit and a transmission unit. The voice receiving unit receives a voice command from a user. The database stores at least one mapping data. The processing unit recognizes the voice command, and obtains a pressing signal generated from the buttons corresponding to the voice command according to mapping data. The transmission unit transmits an inputting signal according to the pressing signal.

The above and other aspects of the invention will become better understood with regard to the following detailed description of the preferred but non-limiting embodiment (s). The following description is made with reference to the accompanying drawings.

### BRIEF DESCRIPTION OF THE DRAWINGS

FIG. 1 is a schematic diagram of a smart inputting device.

FIG. 2 is a flowchart of a setting method of a smart inputting device.

FIG. 3 is a flowchart of a controlling method of a smart inputting device.

### DETAILED DESCRIPTION OF THE INVENTION

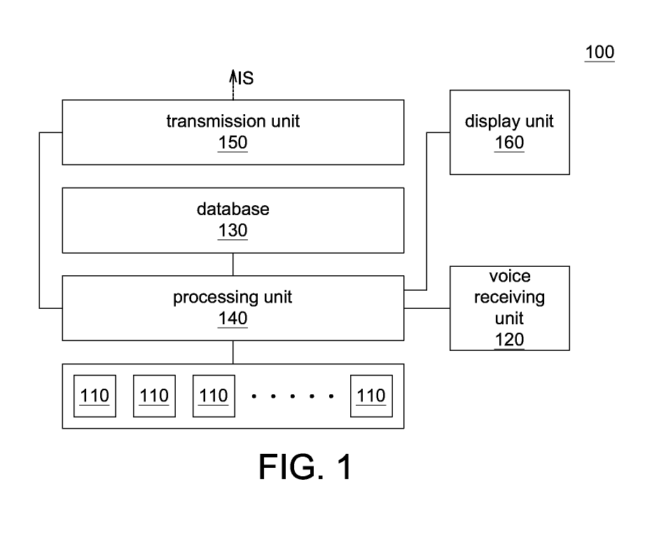

Referring to FIG. 1, a schematic diagram of a smart inputting device is shown. The smart inputting device 100 controls an electronic device, such as a remote controller of a TV or a set top box, an inputting device of a computer, a remote controller of an electric door, a remote controller of a machine, a remote controller of an electronic toy or a remote controller of an air-conditioner. The smart inputting device 100 can be a smart phone or a specific inputting device incorporated with an electronic device. The smart inputting device 100 includes a plurality of buttons 110, a voice receiving unit 120, a database 130, a processing unit 140, a transmission unit 150 and a display unit 160. The buttons 110 are using for the user to input various controlling signals by pressing the buttons 110. The voice receiving unit 120 receives various voice signals, and can be realized by such as a microphone, an audio cable connected to a microphone or a wireless receiver connected to a microphone. The database 130 stores various data, and can be realized by such as a memory, a physical hard disc or a cloud storage. The processing unit 140 executes various recognition procedures, control procedures, computing procedures, or searching procedures, and can be realized by such as a chip, a circuit board containing firmware or a storage medium storing program codes. The transmission unit 150 transmits various signals, and can be realized by such as an infra-red transmitter, a Bluetooth signal transmitter, or a wireless network signal transmitter. The display unit 160 displays various items of information, and can be realized by such as a liquid crystal display, an OLED display, or an e-paper display.

Through the said elements, the smart inputting device 100 allows the user to set his/her own voice command as a specific inputting signal of the smart inputting device 100. On receiving the user's voice command, the smart inputting device 100 can accurately recognize a corresponding inputting signal for controlling the various electronic devices. Recognition accuracy is not affected by different user's pronunciation. Detailed operations of the said elements are disclosed below with an accompanying flowchart.

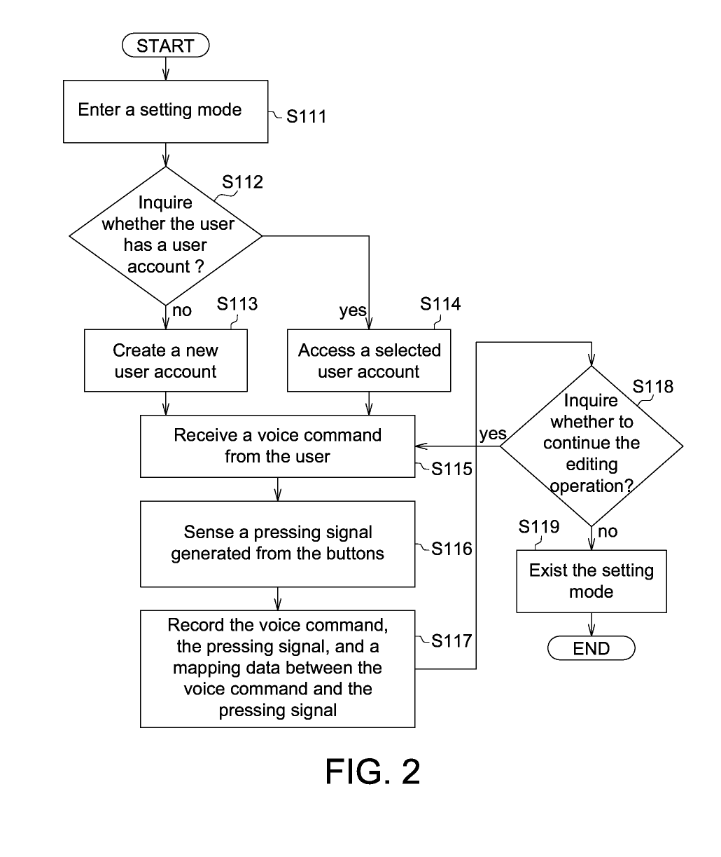

Referring to FIG. 2, a flowchart of a setting method of the smart inputting device 100 is shown. Firstly, in step S111, the smart inputting device 100 enters a setting mode. When entering the setting mode, subsequent operation message can be shown on the display unit 160 or can be shown on the screen of an electronic device.

In steps S112 to S114, a user account is created or selected by the processing unit 140 according to the user's operation command. In step S112, an inquiry option is provided on the display unit 160 by the processing unit 140 to inquire whether the user has a user account. If the response received by the processing unit 140 is “No”, the method proceeds to step S113. If the response received by the processing unit 140 is “Yes”, the method proceeds to step S114. In step S113, various data columns are provided on the display unit 160 by the processing unit 140, and a new user account is created according to the content inputted by the user. In step S114, various selections of user account are provided on the display unit 160 by the processing unit 140, and one of the selected user accounts is accessed according to the user's selection. In another exemplary embodiment, an authentication mechanism, such as private key or password, can be used to protect the user's privacy when creating or accessing the selected user account.

In step S115, a voice command VC is received by the voice receiving unit 120 from the user. The voice command VC can be a word or a long sentence, and is not restricted to any specific languages. For example, the voice command VC can also be music or sounds. Any voice/sound recorded within a recording time can be used as a voice command VC. In an embodiment, the recording time can be a predetermined fixed time. In another embodiment, the recording time can start with the beginning of a voice/sound and end at the vanishing of the voice/sound.

In step S116, a pressing signal PS generated from the buttons 110 is sensed by the processing unit 140. The pressing signal PS may record a single pressing action or a multiple pressings action performed on the buttons 110. Only one of the buttons 110, such as button “9”, can be pressed in the single pressing action. Or, two or more than two of the buttons 110, such as button “Ctrl” and button “C”, can be concurrently pressed in the single pressing action. Some of the buttons 110, such as button “9”, button “9” and button “8”, can be individually and continuously pressed in the multiple pressings action. Or, two or more than two buttons 110 can be concurrently pressed in the multiple pressings action. For example, the button “Ctrl” and the button “A” can be concurrently pressed, and then the button “Delete” can be pressed.

In step S117, the voice command VC, the pressing signal PS, and the mapping data between the voice command VC and the pressing signal PS are recorded in the database 130 by the processing unit 140.

It should be noted that in above embodiments, although the step S115 of receiving the voice command is performed before the step S116 of sensing the pressing signal, the sequence of the two steps is not used to limit the invention. In some embodiment, the step of sensing the pressing signal can be performed before the step of receiving the voice command, and then data is mapped and matched accordingly.

In step S118, an inquiry option is provided on the display unit 160 by the processing unit 140 to inquire whether the user continues his/her editing operation. If the response received by the processing unit 140 is “No”, the method proceeds to step S119. If the response received by the processing unit 140 “Yes”, the method returns to step S115.

In step S119, the smart inputting device 100 exits the setting mode.

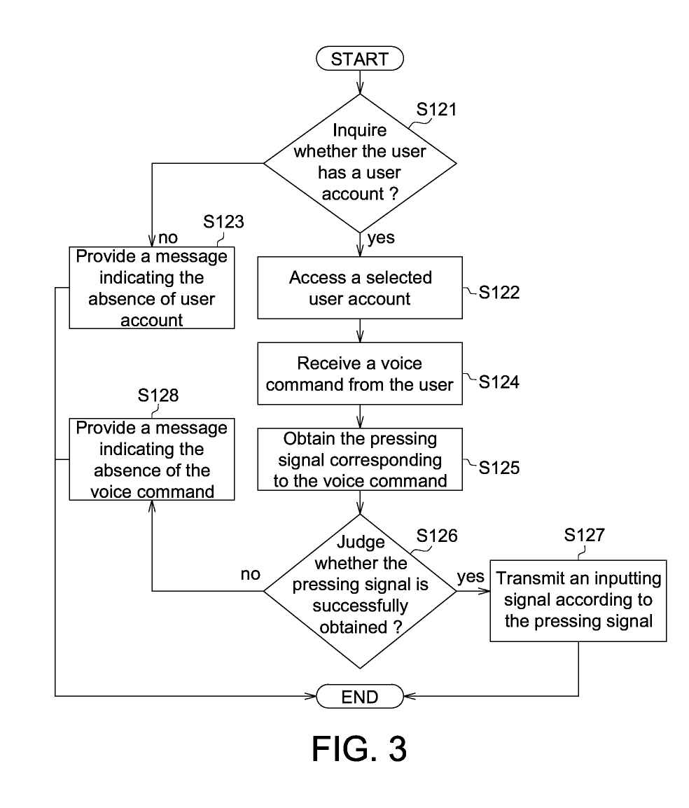

After the above mapping data is created, the user may control the smart inputting device 100 by using the voice command VC to perform various controls on the electronic device. Referring to FIG. 3, a flowchart of a controlling method of the smart inputting device 100 is shown.

Firstly, the method begins at steps S121 to S123, a user account matching the user is selected by the processing unit 140 according to the user's operation command. In step S121, an inquiry option is provided on the display unit 160 by the processing unit 140 to inquire whether the user has a user account. If the response received by the processing unit 140 is “Yes”, the method proceeds to step S122. If the response received by the processing unit 140 is “No”, the method proceeds to step S123. In step S122, various selections of user account are provided on the display unit 160 by the processing unit 140, and the selected user account is accessed according to the user's selection. In step S123, a message is shown on the display unit 160 for indicating that there is no user account, and the method terminates.

In step S124, a voice command VC is received by the voice receiving unit 120 from the user.

In step S125, the pressing signal PS of the buttons 110 corresponding to the voice command VC is obtained by the processing unit 140 according to the mapping data stored in the database 130. In this step, the voice command VC newly received by the voice receiving unit 120 is compared with the existing voice command VC corresponding to the user account by the processing unit 140 for recognition. For example, the voiceprint waveforms are compared for the recognition. If the processing unit 140 recognizes an existing and approximate voice command VC, the processing unit 140 obtains a pressing signal PS corresponding to the existing voice command VC according to the mapping data.

In step S126, whether the pressing signal PS is successfully obtained is judged by the processing unit 140. If the pressing signal PS is successfully obtained, the method proceeds to step S127. If the pressing signal PS is not successfully obtained, the method proceeds to step S128.

In step S127, the transmission unit 150 is controlled by the processing unit 140 to transmit an inputting signal IS for controlling the electronic device according to the pressing signal PS.

In step S128, a message is shown on the display unit 160 by the processing unit 140 for indicating the absence of the voice command VC, and the method terminates.

The said smart inputting device 100 directly stores the voice command VC recorded by each user. When searching the pressing signal PS, the smart inputting device 100 directly compares the newly received voice command VC with the existing voice command VC, and there is no need to convert the voice command VC into text. Therefore, irrespective of user's pronunciation, the user's voice can always be accurately recognized to obtain a corresponding pressing signal PS. Moreover, irrespective of what language the user is using, voice recognition can always be accurately performed to obtain the corresponding pressing signal PS.

In above embodiments, with respect to the situation of multiple users, a user account is created and correlated with the mapping data of different users. In the environment of use in which user structure is simple, for example, the use of household or personal portable device, to reduce software/hardware expenditure and simplify device structure, mapping data can be directly stored in a database, and the creation and authentication of user account can be omitted.

While the invention has been described by way of example and in terms of the preferred embodiment (s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A setting method of a smart inputting device, wherein the smart inputting device comprises a voice receiving unit and a plurality of buttons, and the setting method of the smart inputting device comprises:
receiving a voice command from a user by the voice receiving unit;
sensing a pressing signal generated from the buttons; and
recording a mapping data between the voice command and the pressing signal.

2. The setting method of the smart inputting device according to claim 1, further comprises:
creating or selecting a user account correlated with the mapping data.

3. The setting method of the smart inputting device according to claim 1, wherein the pressing signal records a single pressing action performed on the buttons.

4. The setting method of the smart inputting device according to claim 3, wherein two or more than two of the buttons are concurrently pressed in the single pressing action.

5. The setting method of the smart inputting device according to claim 1, the pressing signal records a multiple pressings action performed on the buttons.

6. The setting method of the smart inputting device according to claim 5, wherein two or more than two of the buttons are concurrently pressed in the multiple pressings action.

7. A controlling method of a smart inputting device, wherein the smart inputting device comprises a voice receiving unit and a plurality of buttons, and the controlling method of the smart inputting device comprises:
obtaining a pressing signal generated from the buttons which is corresponding to a voice command according to a mapping data, if the voice receiving unit receives the voice command from a user; and
transmitting an inputting signal according to the pressing signal.

8. The controlling method of the smart inputting device according to claim 7, wherein before the step of obtaining the pressing signal generated from the buttons which is corresponding to the voice command according to the mapping data, the controlling method of the smart inputting device further comprises:
selecting a user account matching the user, wherein the mapping data is correlated with the user account.

9. The controlling method of the smart inputting device according to claim 7, wherein the pressing signal records a single pressing action performed on the buttons.

10. The controlling method of the smart inputting device according to claim 9, wherein two or more than two of the buttons are concurrently pressed in the single pressing action.

11. The controlling method of the smart inputting device according to claim 7, wherein the pressing signal records a multiple pressings action performed on the buttons.

12. The controlling method of the smart inputting device according to claim 11, wherein two or more than two of the buttons are concurrently pressed in the multiple pressings action.

13. A smart inputting device, comprising:
a plurality of buttons;
a voice receiving unit for receiving a voice command from a user;
a database for storing at least one mapping data;
a processing unit for recognizing the voice command and obtaining a pressing signal generated from the buttons which is corresponding to the voice command according to the mapping data; and
a transmission unit for transmitting an inputting signal according to the pressing signal.

14. The smart inputting device according to claim 13, wherein the at least one mapping data is correlated with at least one user account, which is also stored in the database.

15. The smart inputting device according to claim 13, wherein the pressing signal records a single pressing action performed on the buttons.

16. The smart inputting device according to claim 15, wherein two or more than two of the buttons are concurrently pressed in the single pressing action.

17. The smart inputting device according to claim 13, wherein the pressing signal records a multiple pressings action performed on the buttons.

18. The smart inputting device according to claim 17, wherein two or more than two of the buttons are concurrently pressed in the multiple pressings action.
